(19) United States
(12) Patent Application Publication
(10) Pub. No.: US 2016/0233026 A1
(43) Pub. Date: Aug. 11, 2016

(54) CAPACITOR

(71) Applicant: TAIYO YUDEN CO., LTD., Tokyo (JP)

(72) Inventor: Hidetoshi MASUDA, Tokyo (JP)

(73) Assignee: TAIYO YUDEN CO., LTD., Tokyo (JP)

(21) Appl. No.: 15/023,001

(22) PCT Filed: Mar. 16, 2015
(86) PCT No.: PCT/JP2015/057663

§ 371 Date: Mar. 18, 2016

(30) Foreign Application Priority Data
Mar. 28, 2014 (KR) 2014-069328

(51) Int. Cl. H01G 4/10; H01G 4/228

(52) U.S. Cl. CPC H01G 4/10; H01G 4/228

(57) ABSTRACT

A capacitor includes a dielectric layer, through-holes, a first external electrode layer, a second external electrode layer, first internal electrodes, and second internal electrodes. The dielectric layer is formed by anodic oxidation of metal. The through-holes are a plurality of through-holes that communicate with a first surface of the dielectric layer and a second surface that is the opposite side of the first surface.

### CROSS-REFERENCE TO RELATED APPLICATIONS

This application is a national stage application of PCT Application No. PCT/JP2015/057663, filed Mar. 16, 2015, which claims the benefit of Japanese Application No. JP 2014-069328, filed Mar. 28, 2014, in the Japanese Patent Office. All disclosures of the document(s) named above are incorporated herein by reference in their entireties.

### BACKGROUND OF THE INVENTION

1. Field of the Invention

Aspects of the present invention relate to a porous capacitor.

2. Description of the Related Art

In recent years, as a new type of capacitor, a porous capacitor has been developed. The porous capacitor takes advantage of the tendency of a metal oxide formed on a surface of a metal such as aluminum to form a porous structure (fine through-holes). The porous capacitor is configured by forming internal electrodes in pores and using the metal oxide as a dielectric. Such a capacitor is capable of achieving downsizing and reduction in height compared with laminated capacitors in the related art and is increasingly demanded in mobile communication devices that support higher frequency.

External conductors are laminated on front and back surfaces of the dielectric. The internal electrodes formed in the pores are connected to either one of the external conductors on the front surface and the external conductor on the back surface. The external conductor not connected to the internal electrodes is insulated by voids or an insulating material. Thus, the internal electrodes function as opposing electrodes (positive electrodes or negative electrodes) facing each other via the dielectric.

For example, Patent Document 1 and Patent Document 2 each disclose a porous capacitor having such a configuration. In both of the Patent Documents, the internal electrodes are formed in the pores, one end of each internal electrode is connected to one of the conductors, and the other end thereof is insulated from the other conductor.

Patent Document 1: Japanese Patent Application Laid-open No. 4493686

Patent Document 2: Japanese Patent Application Laid-open No. 2009-76850

### SUMMARY OF THE INVENTION

### Problem to be Solved by the Invention

When a porous capacitor using an aluminum oxide for a dielectric is exposed in a humidity environment, a hydration reaction proceeds and a dielectric material that forms the dielectric is converted into a hydrate. Since the hydrate is inferior in insulation properties, when the hydrate is formed to extend over the positive and negative internal electrodes in the peripheral portions of the external conductors, there arises a problem that the external conductors respectively laminated on the front and back surfaces of the dielectric are electrically connected to each other, and a short-circuit fault of the capacitor is caused.

Normally, in order to avoid the short-circuit fault by the hydrate, the porous capacitor has a configuration in which the external conductors are covered by protective layers slightly larger than the external conductors, and the entry of humidity to the dielectric layer is prevented in the peripheral portions of the external conductors. Even in this configuration, however, there arises a problem that when the protective layers have a pinhole or the like, the humidity entering the pinhole reaches the dielectric in the peripheral portions of the external conductors and this leads to a short-circuit fault.

In view of the circumstances as described above, it is an object of the present invention to provide a porous capacitor capable of preventing occurrence of a short-circuit fault due to the generation of a hydrate in a dielectric layer.

### Ways for Solving the Problem

To achieve the above object, according to an embodiment of the present invention, there is provided a capacitor including a dielectric layer, a first external electrode layer, a second external electrode layer, first internal electrodes, and second internal electrodes.

The dielectric layer is formed by anodic oxidation of metal, has a first surface and a second surface on the opposite side of the first surface, and includes a plurality of through-holes that communicate with the first surface and the second surface.

The first external electrode layer is disposed on the first surface.

The second external electrode layer is disposed on the second surface and includes an opposing area and a non-opposing area, the opposing area facing the first external electrode layer via the dielectric layer, and the non-opposing area not facing the first external electrode layer via the dielectric layer.

The first internal electrodes are formed in some of the plurality of through-holes, connected to the first external electrode layer, and separated from the second external electrode layer.

The second internal electrodes are formed in other ones of the plurality of through-holes, connected to the second external electrode layer, and separated from the first external electrode layer.

With this configuration, the first internal electrodes and the second internal electrodes that face each other via the dielectric layer function as opposing electrodes of the capacitor. The first internal electrodes are connected to the first external electrode layer, and the second internal electrodes are connected to the second external electrode layer. Those internal electrodes are connected to the outside (connection terminals, etc.) via those external electrode layers. Here, when the capacitor is exposed in a high humidity environment, a hydration reaction occurs in the dielectric material and a hydrate is generated in some cases. Since the hydrate is inferior in insulation properties, when the hydrate is generated to extend over the positive and negative internal electrodes in the peripheral portions of the external conductors, there is a possibility that the external electrode layers respectively disposed on the front and back surfaces of the dielectric layer are electrically connected to each other, and a short-circuit fault of the capacitor occurs.

Even in such a case, when the second external electrode layer is configured to have an area that faces the first external electrode layer via the dielectric layer (opposing area) and an area that does not face the first external electrode layer via the dielectric layer (non-opposing area), the external electrode layers are not electrically connected to each other via the internal electrodes even when a hydrate is generated in the peripheral portion of the dielectric layer. This can prevent a short-circuit fault of the capacitor.

The first external electrode layer may include an opposing area and a non-opposing area, the opposing area facing the second external electrode layer via the dielectric layer, and the non-opposing area not facing the second external electrode layer via the dielectric layer.

With this configuration, areas where a short circuit via the internal electrodes does not occur even when a hydrate is formed are formed on both of the first surface and the second surface. Thus, it is possible to reduce a probability of occurrence of a short-circuit fault on both of the surfaces.

The opposing area may be surrounded by the non-opposing area.

When the opposing area is surrounded by the non-opposing area, an area where a short circuit between the first internal electrodes and the second internal electrodes occurs due to the hydrate is only on the first surface side of the dielectric layer. Therefore, when the capacitor is mounted on a substrate, the first surface side is mounted to face the substrate and an underfill is provided thereto. This can prevent entry of moisture to the first surface side and prevent the generation of a hydrate on the first surface side. Since conduction due to the hydrate is prevented on the second surface side as described above, it is possible to prevent the occurrence of a short-circuit fault and further enhance the reliability of the capacitor.

The non-opposing area may have a width of 0.1 μm or more and 100 μm or less.

With this configuration, by setting of the width of the non-opposing area to be 0.1 μm or more and 100 μm or less, it is possible to reduce a probability of a short-circuit fault while ensuring an electrical capacitance of the capacitor.

Gaps between the first internal electrodes and the second external electrode layer and gaps between the second internal electrodes and the first external electrode layer may be filled with an insulating material.

With this configuration, by filing with the insulating material, it is possible to ensure insulation between the first internal electrodes and the second external electrode layer and between the second internal electrodes and the first external electrode layer.

The dielectric layer may be made of a material that forms pores by a self-organizing effect when being subjected to the anodic oxidation.

With this configuration, by the anodic oxidation of the material, it is possible to form a dielectric layer including through-holes (pores).

The dielectric layer may be made of an aluminum oxide formed by the anodic oxidation of aluminum.

An aluminum oxide generated by the anodic oxidation of aluminum forms through-holes by the self-organizing effect in the process of oxidation. Specifically, by the anodic oxidation of aluminum, it is possible to form a dielectric layer including through-holes.

### Effect of the Invention

According to an aspect of the present invention, it is possible to provide a porous capacitor capable of preventing occurrence of a short-circuit fault due to the generation of a hydrate in a dielectric layer.

### BRIEF DESCRIPTION OF THE DRAWINGS

FIG. 1 is a perspective view of a capacitor according to the present invention.

FIG. 2 is a cross-sectional view of the capacitor.

FIG. 3 is a perspective view of a dielectric layer of the capacitor.

FIG. 4 is a cross-sectional view of the dielectric layer of the capacitor.

FIG. 5 is a cross-sectional view showing a part of a configuration of the capacitor.

FIG. 6 is a perspective view showing a part of the configuration of the capacitor.

FIG. 7 is a cross-sectional view showing a part of the configuration of the capacitor.

FIG. 8 is a cross-sectional view showing a part of the configuration of the capacitor.

FIG. 9 is a perspective view showing a part of the configuration of the capacitor.

FIG. 10 is a perspective view showing a part of the configuration of the capacitor.

FIG. 11 is a cross-sectional view showing a part of the configuration of the capacitor.

FIG. 12 is a plan view showing a part of the configuration of the capacitor.

FIG. 13 is a plan view showing a part of the configuration of the capacitor.

FIG. 14 is a schematic view showing a configuration variation in the capacitor.

FIG. 15 is a schematic view showing a configuration variation in the capacitor.

FIG. 16 is a schematic view showing a configuration variation in the capacitor.

FIG. 17 is a schematic view showing a configuration variation in the capacitor.

FIG. 18 is a cross-sectional view of a capacitor according to a comparative example of the present invention.

FIG. 19 is an enlarged perspective view of the capacitor.

FIG. 20 is an enlarged perspective view of the capacitor.

FIG. 21 is a cross-sectional view showing a part of the configuration of the capacitor.

FIG. 22 is an enlarged perspective view of the capacitor according to an aspect of the present invention.

FIG. 23 is a cross-sectional view showing a part of the configuration of the capacitor.

FIG. 24 is a cross-sectional view showing a part of the configuration of the capacitor.

FIG. 25 is a schematic view showing a mount form in the capacitor.

FIG. 26 is a schematic view showing a manufacturing process of the capacitor.

FIG. 27 is a schematic view showing a manufacturing process of the capacitor.

FIG. 28 is a schematic view showing a manufacturing process of the capacitor.

FIG. 29 is a schematic view showing a manufacturing process of the capacitor.

FIG. 30 is a schematic view showing a manufacturing process of the capacitor.

FIG. 31 is a schematic view showing a manufacturing process of the capacitor.

FIG. 32 is a schematic view showing a manufacturing process of the capacitor.

### MODE(S) FOR CARRYING OUT THE INVENTION

### [Configuration of Capacitor]

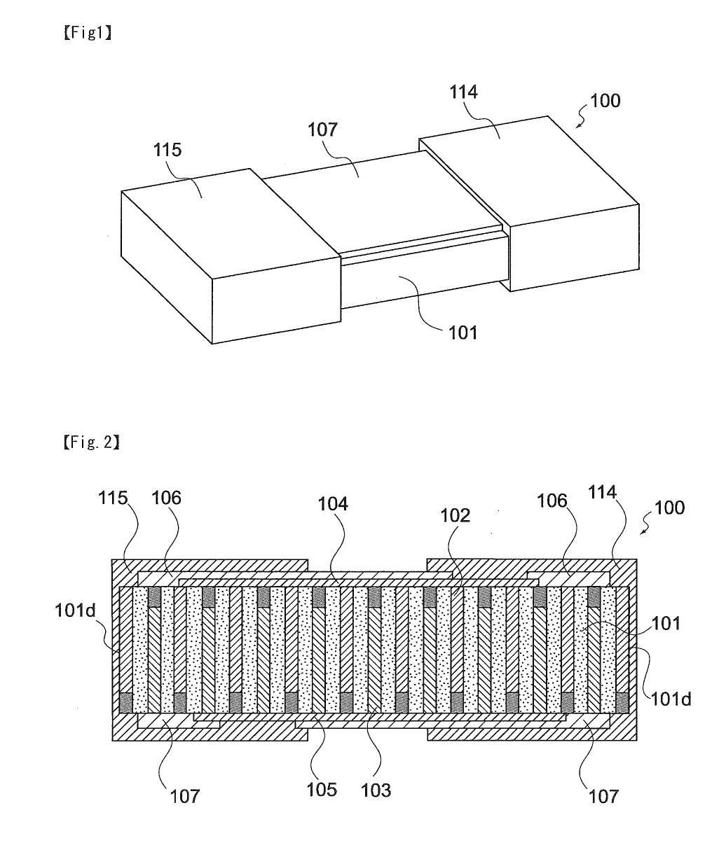

FIG. 1 is a perspective view of a capacitor 100 according to the present invention. FIG. 2 is a cross-sectional view of the capacitor 100. As shown in those figures, the capacitor 100 includes a dielectric layer 101, first internal electrodes 102, second internal electrodes 103, a first external electrode layer 104, a second external electrode layer 105, a first protective layer 106, a second protective layer 107, a first external terminal 114, and a second external terminal 115.

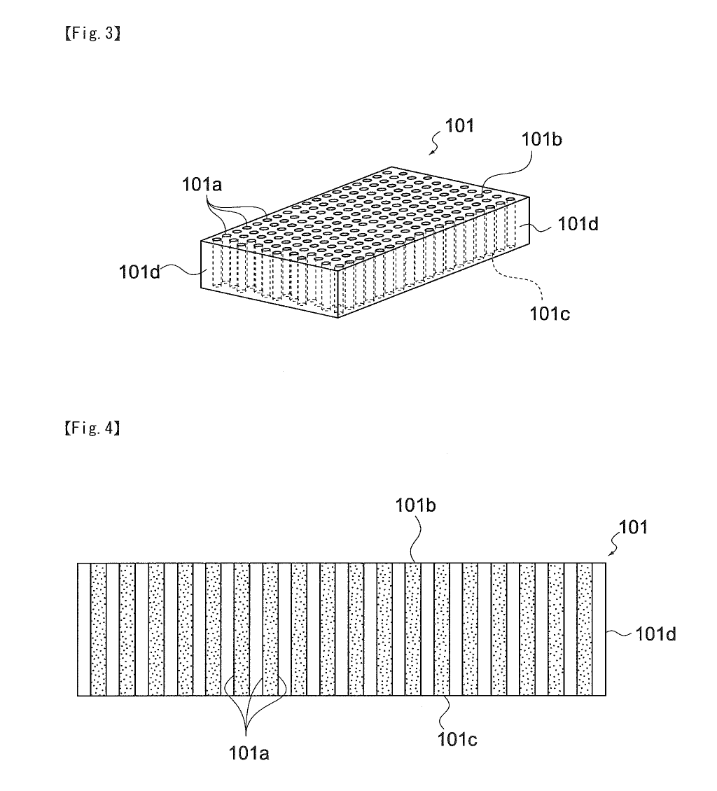

The dielectric layer 101 functions as a dielectric of the capacitor 100. FIG. 3 is a perspective view of the dielectric layer 101. FIG. 4 is a cross-sectional view of the dielectric layer 101. The dielectric layer 101 can be made of a dielectric material capable of forming pores by a self-organizing effect. Examples of such a material include an aluminum oxide (Al₂O₃). The thickness of the dielectric layer 101 is not particularly limited. For example, the dielectric layer 101 can have a thickness of several μm to several hundred μm.

As shown in FIGS. 3 and 4, a plurality of through-holes 101a are formed in the dielectric layer 101. Assuming that a surface parallel to a layer surface direction of the dielectric layer 101 is a first surface 101b and a surface on the other side is a second surface 101c, the through-holes 101a are formed along a direction perpendicular to the first surface 101b and the second surface 101c (thickness direction of the dielectric layer 101) and formed so as to communicate with the first surface 101b and the second surface 101c. It should be noted that the number and the size of through-holes 101a shown in FIG. 3 or the like are illustrative for convenience, and actual ones are smaller and more numerous. Further, the through-holes 101a may have branches and join to adjacent through-holes 101a. Further, in the dielectric layer 101, a side surface with respect to the first surface 101b and the second surface 101c is denoted as a side surface 101d.

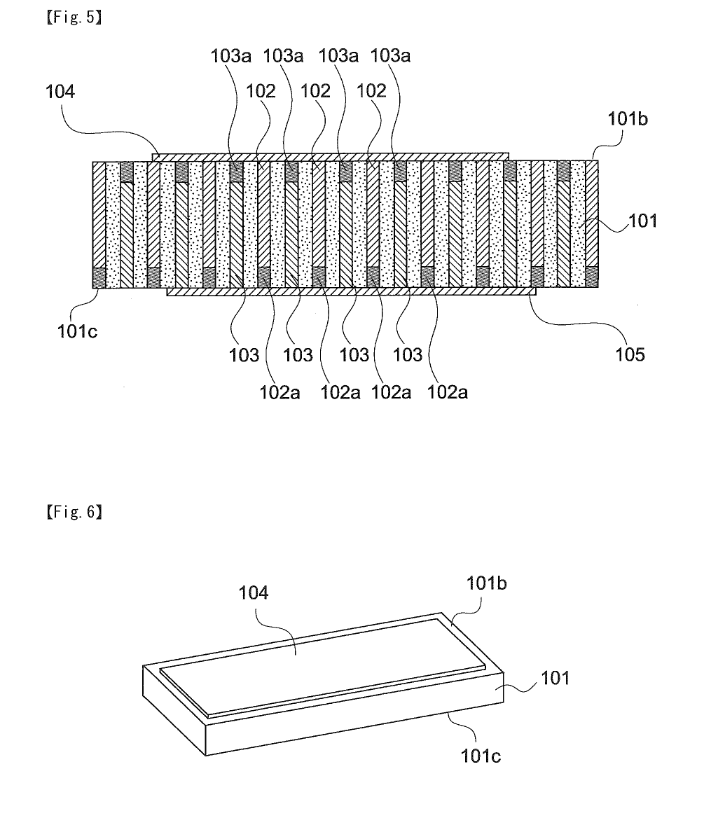

The first internal electrodes 102 function as opposing electrodes on one side of the capacitor 100. FIG. 5 is a cross-sectional view showing a part of a configuration of the capacitor 100. The first internal electrodes 102 may be made of a conductive material, e.g., a pure metal such as In, Sn, Pb, Cd, Bi, Al, Cu, Ni, Au, Ag, Pt, Pd, Co, Cr, Fe, or Zn, or an alloy thereof.

As shown in FIG. 5, the first internal electrodes 102 are connected to the first external electrode layer 104 and formed to be separated from the second external electrode layer 105. As shown in the figure, insulators 102a made of an insulating material are formed between the first internal electrodes 102 and the second external electrode layer 105. Alternatively, the insulators 102a may be voids provided between the first internal electrodes 102 and the second external electrode layer 105.

Here, all of the first internal electrodes 102 are not connected to the first external electrode layer 104. The first internal electrodes 102 located in an area of the first surface 101b where the first external electrode layer 104 is not disposed are not connected to the first external electrode layer 104. An area where the first external electrode layer 104 is disposed will be described later.

The second internal electrodes 103 function as opposing electrodes on the other side of the capacitor 100. The second internal electrodes 103 may be made of a conductive material, e.g., a pure metal such as In, Sn, Pb, Cd, Bi, Al, Cu, Ni, Au, Ag, Pt, Pd, Co, Cr, Fe, or Zn, or an alloy thereof.

As shown in FIG. 5, the second internal electrodes 103 are connected to the second external electrode layer 105 and formed to be separated from the first external electrode layer 104. As shown in the figure, insulators 103a made of an insulating material are formed between the second internal electrodes 103 and the first external electrode layer 104. Alternatively, the insulators 103a may be voids provided between the second internal electrodes 103 and the first external electrode layer 104.

Here, all of the second internal electrodes 103 are not connected to the second external electrode layer 105. The second internal electrodes 103 located in an area of the second surface 101c where the second external electrode layer 105 is not disposed are not connected to the second external electrode layer 105. An area where the second external electrode layer 105 is disposed will be described later.

The first internal electrodes 102 and the second internal electrodes 103 are illustrated to be alternately arrayed in FIG. 5. However, the first internal electrodes 102 and the second internal electrodes 103 may not be necessarily alternately arrayed but be randomly arranged. This is because a capacitor is configured as long as the first internal electrodes 102 and the second internal electrodes 103 are disposed to face each other via the dielectric layer 101. The number of first internal electrodes 102 and the number of second internal electrodes 103 may not be equal to each other, but if the numbers thereof are equal to each other, the capacitance of the capacitor is increased, which is suitable.

As shown in FIG. 5, the first external electrode layer 104 is disposed on the first surface 101b. The first external electrode layer 104 may be made of a conductive material, e.g., a pure metal such as Cu, Ni, Cr, Ag, Pd, Fe, Sn, Pb, Pt, Ir, Rh, Ru, Al, or Ti, or an alloy thereof. The thickness of the first external electrode layer 104 may be several ten nm to several μm, for example. Further, the first external electrode layer 104 may be formed of a plurality of conductive material layers disposed to be laminated.

As shown in FIG. 2, the first external electrode layer 104 electrically connects the first internal electrodes 102 and the first external terminal 114. FIG. 6 is a perspective view showing the first external electrode layer 104. As shown in FIGS. 5 and 6, the first external electrode layer 104 only needs to be disposed on at least the first surface 101b and may not necessarily have a configuration to cover the entire first surface 101b.

As shown in FIG. 5, the second external electrode layer 105 is disposed on the second surface 101c. The second external electrode layer 105 may be made of a conductive material, e.g., a pure metal such as Cu, Ni, Cr, Ag, Pd, Fe, Sn, Pb, Pt, Ir, Rh, Ru, Al, or Ti, or an alloy thereof. The thickness of the second external electrode layer 105 may be several ten nm to several μm, for example. Further, the second external electrode layer 105 may be formed of a plurality of conductive material layers disposed to be laminated.

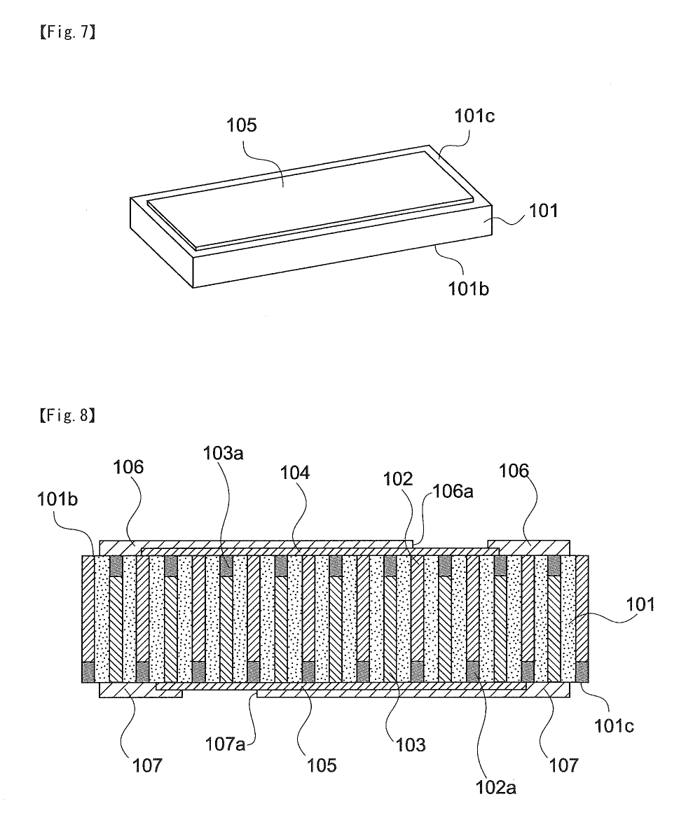

As shown in FIG. 2, the second external electrode layer 105 electrically connects the second internal electrodes 103 and the second external terminal 115. FIG. 7 is a perspective view showing the second external electrode layer 105. As shown in FIGS. 5 and 7, the second external electrode layer 105 only needs to be disposed on at least the second surface 101c and may not necessarily have a configuration to cover the entire second surface 101c.

Here, the first external electrode layer 104 and the second external electrode layer 105 do not totally face each other. An area of the first external electrode layer 104 and an area of the second external electrode layer do not face each other. Areas where the first external electrode layer 104 and the second external electrode layer 105 are disposed will be described later.

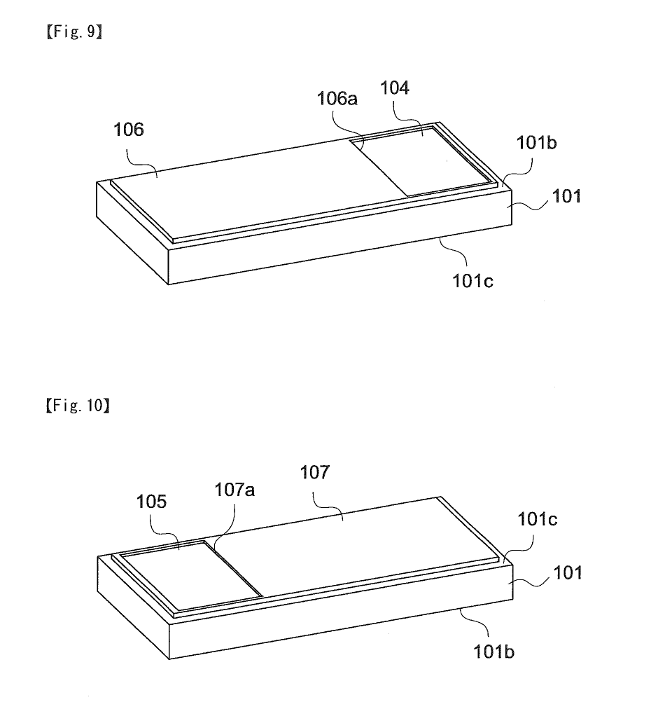

As shown in FIG. 2, the first protective layer 106 covers the first external electrode layer 104 and insulates the first external electrode layer 104 from the second external terminal 115. FIG. 8 is a cross-sectional view showing a part of the configuration of the capacitor 100. FIG. 9 is a perspective view showing the first protective layer 106. The first protective layer 106 is disposed on the first surface 101b and on the first external electrode layer 104 as well. As shown in FIGS. 8 and 9, the first protective layer 106 is configured such that an aperture 106a is formed on the first external electrode layer 104 and the first external electrode layer 104 is exposed by the aperture 106a. The shape, the size, and the number of apertures 106a are not particularly limited.

As shown in FIG. 2, the second protective layer 107 covers the second external electrode layer 105 and insulates the second external electrode layer 105 from the first external terminal 114. FIG. 10 is a perspective view showing the second protective layer 107. The second protective layer 107 is disposed on the second surface 101c and on the second external electrode layer 105 as well. As shown in FIGS. 8 and 10, the second protective layer 107 is configured such that an aperture 107a is formed on the second external electrode layer 105 and the second external electrode layer 105 is exposed by the aperture 107a. The shape, the size, and the number of apertures 107a are not particularly limited.

The first protective layer 106 and the second protective layer 107 are each made of an insulating material. A material particularly excellent in humidity resistance is suitable for the first protective layer 106 and the second protective layer 107. As an index of the humidity resistance, a material having hygroscopicity of 2% or less and moisture permeability of 1 mg/mm² or less per thickness of 1 μm is suitable. Examples of such a material include an epoxy resin, a silicone resin, a polyimide resin, and a polyolefin resin.

The first external terminal 114 functions as a terminal of the first internal electrodes 102. As shown in FIGS. 1 and 2, the first external terminal 114 is disposed on the first protective layer 106, the second protective layer 107, and the first external electrode layer 104, and on the side surface 101d between the first protective layer 106 and the second protective layer 107. The first external terminal 114 is electrically connected to the first internal electrodes 102 via the first external electrode layer 104. Specifically, the first external terminal 114 functions as a terminal that connects the first internal electrodes 102 and the outside.

The second external terminal 115 functions as a terminal of the second internal electrodes 103. As shown in FIGS. 1 and 2, the second external terminal 115 is disposed on the first protective layer 106, the second protective layer 107, and the second external electrode layer 105, and on the side surface 101d between the first protective layer 106 and the second protective layer 107. The second external terminal 115 is electrically connected to the second internal electrodes 103 via the second external electrode layer 105. Specifically, the second external terminal 115 functions as a terminal that connects to the second internal electrodes 103.

The capacitor 100 has the configuration as described above. It should be noted that as described above, in the capacitor 100, the first internal electrodes 102 and the second internal electrodes 103 face each other via the dielectric layer 101 to form a capacitor. Specifically, the first internal electrodes 102 and the second internal electrodes 103 function as opposing electrodes of the capacitor. It should be noted that any of the first internal electrodes 102 and the second internal electrodes 103 may be positive electrodes. The first internal electrodes 102 are connected via the first external electrode layer 104, and the second internal electrodes 103 are connected via the second external electrode layer 105, to respective external wirings and terminals and the like.

[Regarding Areas where First External Electrode Layer and Second External Electrode Layer are Disposed]

Areas where the first external electrode layer 104 and the second external electrode layer 105 of the capacitor according to this embodiment are disposed will be described.

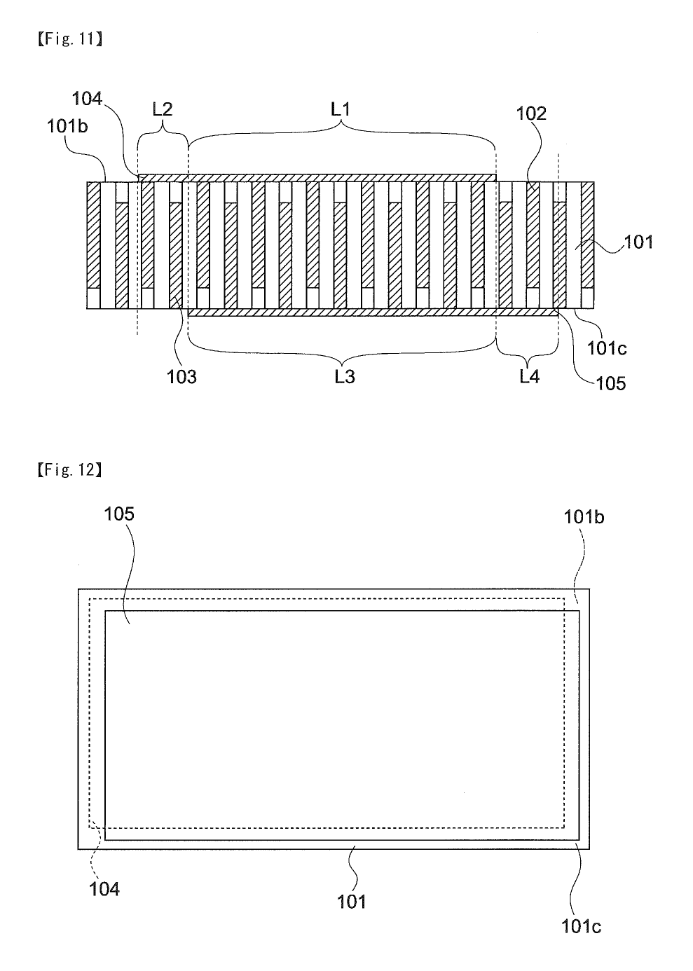

As described above, the first external electrode layer 104 and the second external electrode layer 105 have areas where the first external electrode layer 104 and the second external electrode layer 105 do not face each other via the dielectric layer 101. FIG. 11 is a cross-sectional view showing a part of the configuration of the capacitor 100. FIG. 12 is a plan view showing a part of the configuration of the capacitor 100 viewed from the second surface 101c side.

As shown in those figures, the first external electrode layer 104 and the second external electrode layer 105 may be equal to each other in size and may be disposed with a displacement in the layer surface direction (direction orthogonal to the thickness) without totally facing each other via the dielectric layer 101. Thus, the first external electrode layer 104 and the second external electrode layer 105 have opposing areas and non-opposing areas.

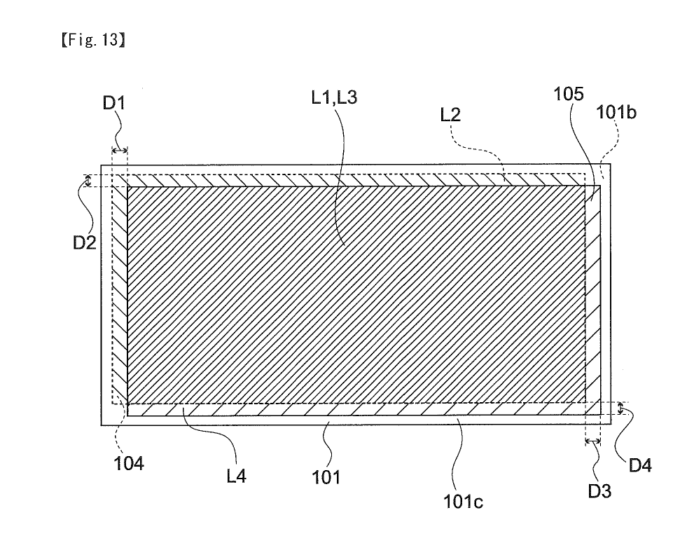

FIG. 13 is a schematic view showing opposing areas and non-opposing areas in the first external electrode layer 104 and the second external electrode layer 105. As shown in the figure, the first external electrode layer 104 includes an opposing area L1 and a non-opposing area L2. The opposing area L1 is an area that faces the second external electrode layer 105. The non-opposing area L2 is an area that does not face the second external electrode layer 105. Further, the second external electrode layer 105 includes an opposing area L3 and a non-opposing area L4. The opposing area L3 is an area that faces the first external electrode layer 104. The non-opposing area L4 is an area that does not face the first external electrode layer 104.

Here, as shown in FIG. 11, the second internal electrodes 103 formed within the opposing area L1 are connected to the second external electrode layer 105, and the second internal electrodes 103 formed within the non-opposing area L2 are not connected to the second external electrode layer 105. Further, the first internal electrodes 102 formed within the opposing area L3 are connected to the first external electrode layer 104, and the first internal electrodes 102 formed within the non-opposing area L4 are not connected to the first external electrode layer 104.

As shown in FIG. 13, the non-opposing area L2 may be provided along one long side and one short side of the first external electrode layer 104, and the non-opposing area L4 may be provided along one long side and one short side of the second external electrode layer 105. As shown in the figure, the width of the non-opposing area L2 (a distance between the periphery of the opposing area L1 and the periphery of the non-opposing area L2) is assumed to be a width D1 and a width D2, and the width of the non-opposing area L4 (a distance between the periphery of the opposing area L3 and the periphery of the non-opposing area LL4) is assumed to be a width D3 and a width D4. It should be noted that the widths D1 to D4 may be identical to one another or may be different from one another. The widths D1 to D4 are not particularly limited, but the width of 0.1 μm or more and 100 μm or less is suitable.

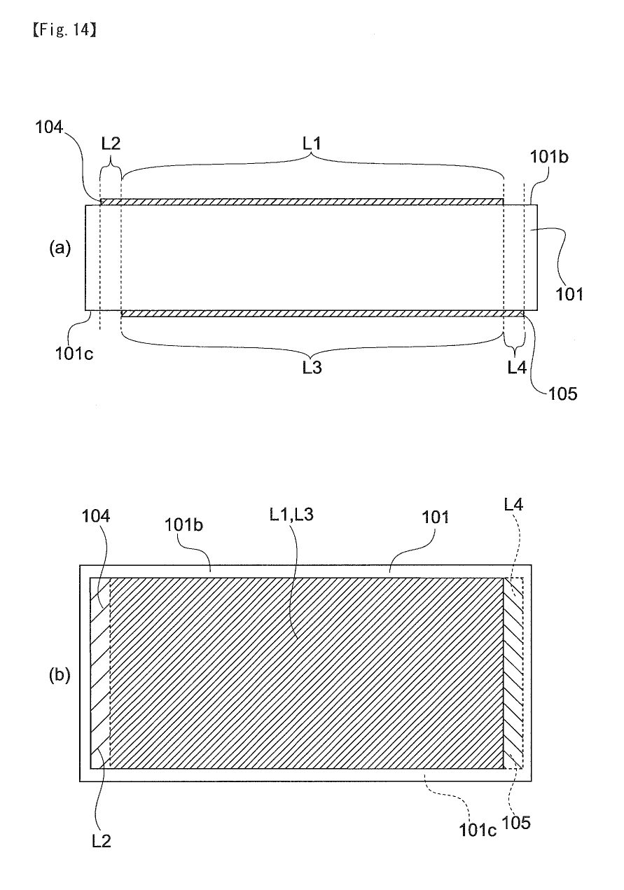

It should be noted that the areas where the first external electrode layer 104 and the second external electrode layer 105 are disposed are not limited to those described above. FIGS. 14(a) to 17(b) are schematic views each showing a variation in the areas where the first external electrode layer 104 and the second external electrode layer 105 are disposed. FIGS. 14(a) to 17(a) are cross-sectional views of the respective capacitors 100. FIGS. 14(b) to 17(b) are plan views corresponding to the respective cross-sectional views. It should be noted that each of the plan views shows the capacitor 100 viewed from the second surface 101b side.

For example, as shown in FIG. 14, the first external electrode layer 104 and the second external electrode layer 105 may be equal to each other in size and may be disposed with a displacement in one direction of the layer surface direction. Thus, the non-opposing area L2 can be provided along one short side of the opposing area L1, and the non-opposing area L4 can be provided along one short side of the opposing area L3.

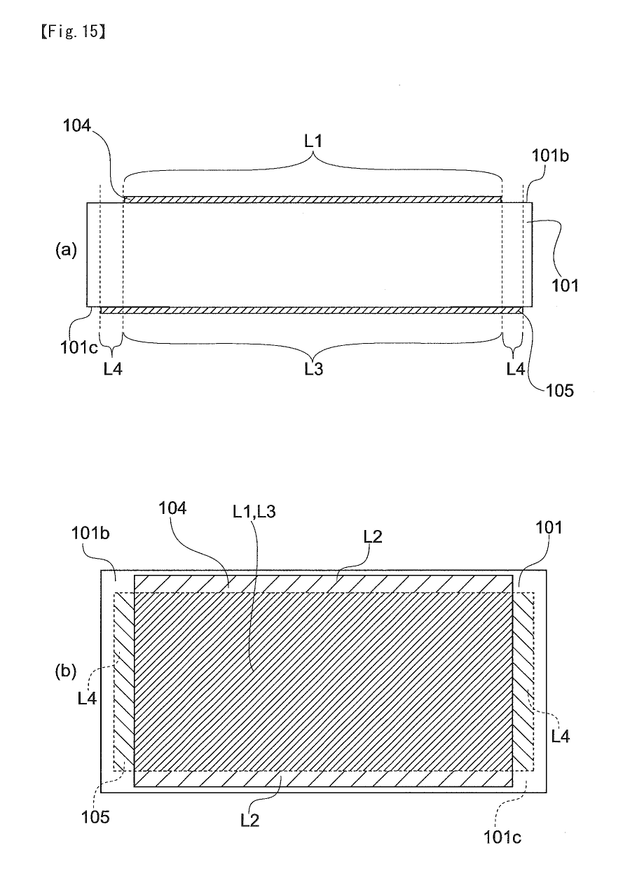

Alternatively, the first external electrode layer 104 and the second external electrode layer 105 may be different from each other in size. For example, as shown in FIG. 15, the first external electrode layer 104 and the second external electrode layer 105 may be different from each other in length of the long side and the short side. Thus, the non-opposing areas L2 can be provided along the long sides of the opposing area L1, and the non-opposing areas L4 can be provided along the long sides of the opposing area L3.

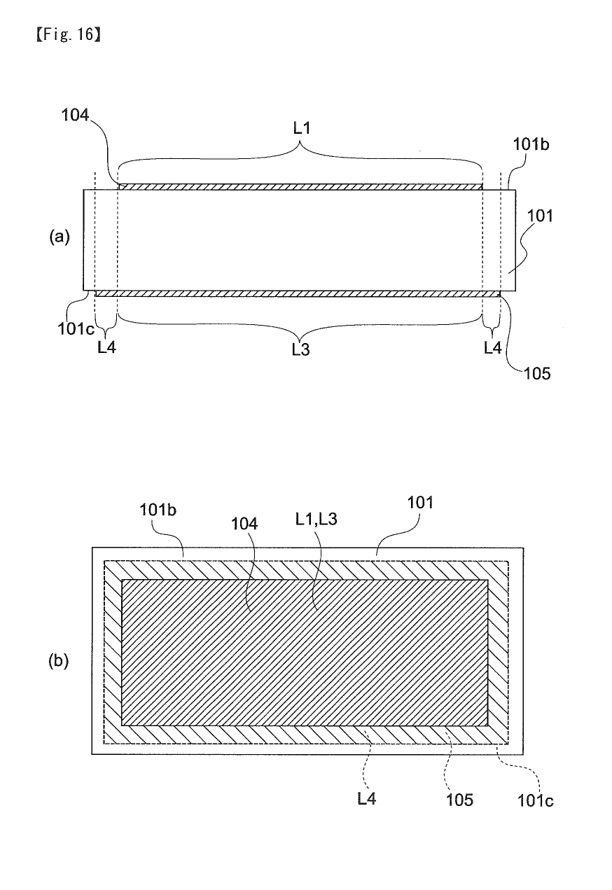

Further, as shown in FIG. 16, the second external electrode layer 105 may be larger than the first external electrode layer 104 in all the sides, and all the sides of the second external electrode layer 105 and all the sides of the first external electrode layer may be separated from each other when viewed from the thickness direction. Thus, the opposing area L3 can be surrounded by the non-opposing area L4, and the first external electrode layer 104 does not include the non-opposing area L2.

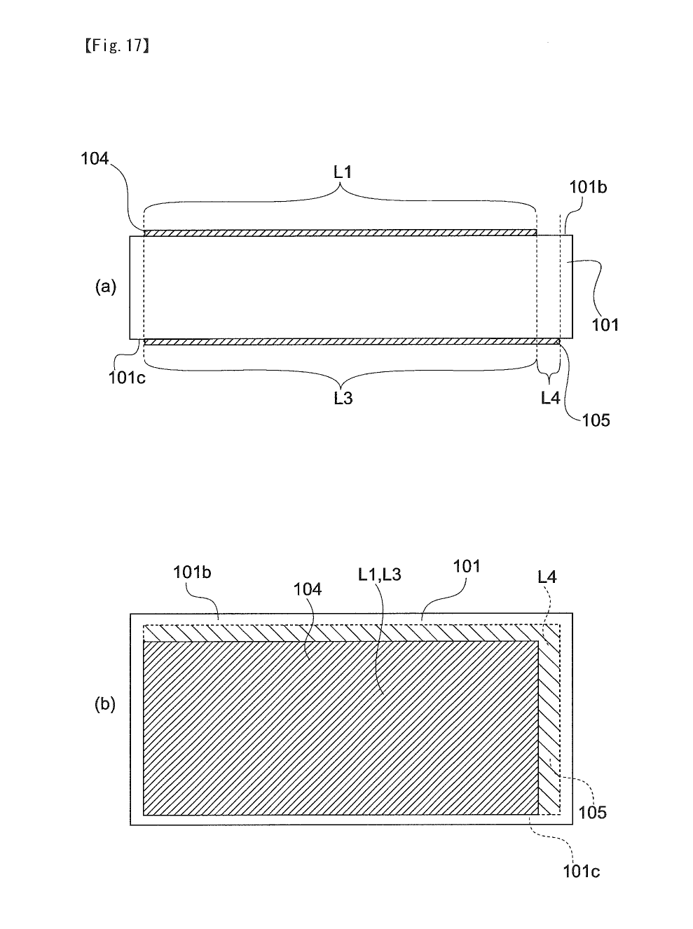

Furthermore, as shown in FIG. 17, the second external electrode layer 105 may be larger than the first external electrode layer 104 in all the sides, and one long side and one short side of the second external electrode layer 105 and one long side and one short side of the first external electrode layer 104 may be separated from each other when viewed from the thickness direction. Thus, the non-opposing area L4 can be provided along one short side and one long side of the opposing area L3, and the first external electrode layer 104 does not include the non-opposing area L2.

Also in each of those configurations, the widths of the non-opposing area L2 and the widths of the non-opposing area L4 (see FIG. 13) are not particularly limited, but the width of 0.1 μm or more and 100 μm or less is suitable. It should be noted that the non-opposing area L2 is not present in the first external electrode layer 104 as described above in some cases.

The configurations of the first external electrode layer 104 and the second external electrode layer 105 are not limited to those described herein. The second external electrode layer 105 only needs to include at least the opposing area L3 and the non-opposing area L4. The shapes of the first external electrode layer 104 and the second external electrode layer 105 are not limited to a rectangle, and may be a circle, an ellipse, or a multangular shape.

### [Effect of Capacitor]

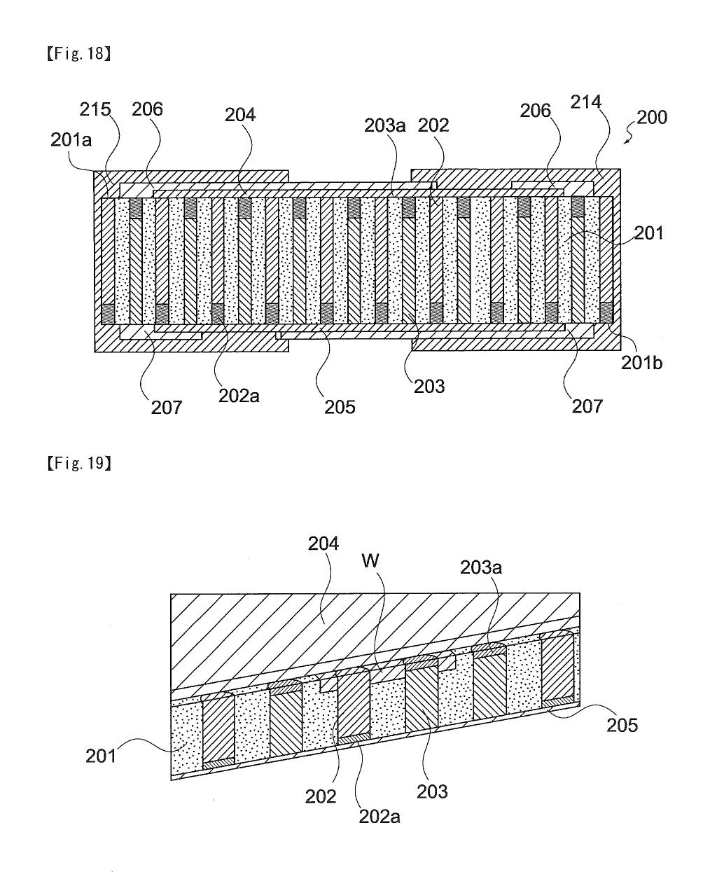

The effect of the capacitor 100 will be described using a comparative example. FIG. 18 is a cross-sectional view of a capacitor 200 according to a comparative example. As shown in the figure, the capacitor 200 includes a dielectric layer 201, first internal electrodes 202, second internal electrodes 203, a first external electrode layer 204, a second external electrode layer 205, a first protective layer 206, a second protective layer 207, a first external terminal 214, and a second external terminal 215. Further, gaps between the first internal electrodes 202 and the second external electrode layer 205 are filled with insulators 202a, and gaps between the second internal electrodes 203 and the first external electrode layer 204 are filled with insulators 203a.

As shown in FIG. 18, in the dielectric layer 201, the first external electrode layer 204 is disposed on a first surface 201a, and the second external electrode layer 205 is disposed on a second surface 201b. The first external electrode layer 204 and the second external electrode layer 205 are equal to each other in size and configured to totally face each other via the dielectric layer 201.

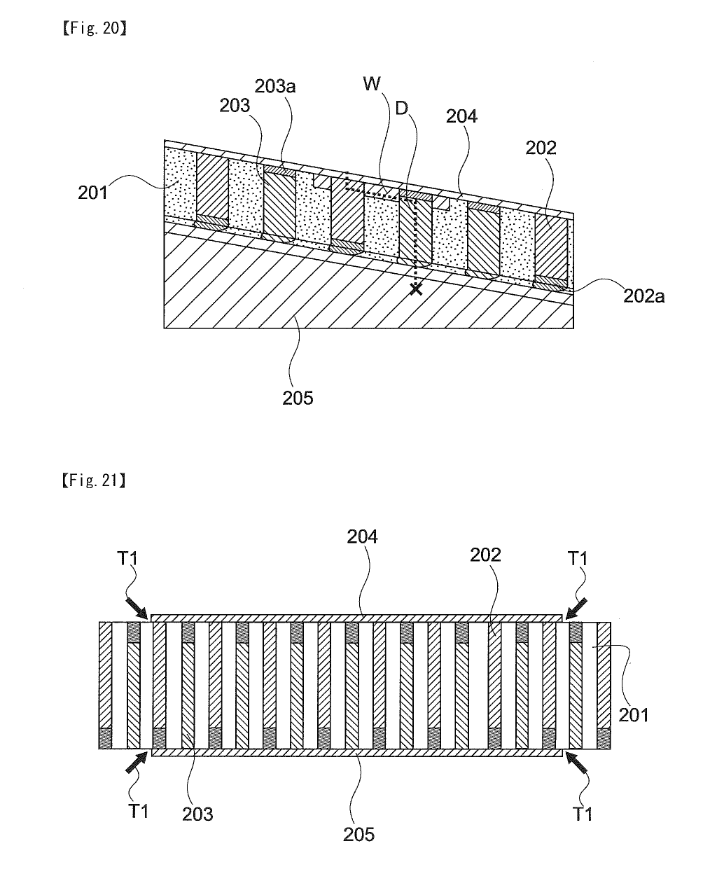

FIGS. 19 and 20 are each an enlarged view of the capacitor 200 in the peripheral portions of the first external electrode layer 204 and the second external electrode layer 205 and each show a state where the dielectric layer 201 is cut in the vicinity of the peripheral portions of the first external electrode layer 204 and the second external electrode layer 205. It should be noted that the first protective layer 206, the second protective layer 207, the first external terminal 214, and the second external terminal 215 are not illustrated in both of the figures.

Here, when the capacitor 200 is exposed in a humidity environment, a hydration reaction occurs in the dielectric layer 201 and a hydrate of boehmite or the like is generated. The dielectric layer 201 is covered by the first protective layer 206 and the second protective layer 207. However, when the first protective layer 206 and the second protective layer 207 have pinholes, there is a possibility that moisture reaches the dielectric layer 201.

Since the first external electrode layer 204 and the second external electrode layer 205 are formed on the first surface 201a and the second surface 201b of the dielectric layer 201, respectively, the infiltrated moisture reaches the peripheral portions of the first external electrode layer 204 and the second external electrode layer 205.

Thus, for example, as shown in FIG. 19, a hydrate W is formed in the dielectric layer 201 in the peripheral portion of the first external electrode layer 204. Since the hydrate W is inferior in insulation properties, when the hydrate W is formed to extend over the first internal electrode 202 and the second internal electrode 203, the first internal electrode 202 and the second internal electrode 203 are electrically connected to each other as shown in FIG. 20. Therefore, there is a possibility that the first external electrode layer 204 connected to the first internal electrode 202 and the second external electrode layer 205 connected to the second internal electrode 203 are electrically connected to each other (in the figure, conduction path D), and a short-circuit fault is caused.

Such a short-circuit fault due to the hydrate occurs because the second external electrode layer 205 is present on the opposite side of the peripheral portion of the first external electrode layer 204 via the dielectric layer 201. It should be noted that the peripheral portion of the first external electrode layer 204 has been described here, but the peripheral portion of the second external electrode layer 205, which is the opposite side of the dielectric layer 201, also has a possibility that a short-circuit fault due to a hydrate occurs.

FIG. 21 is a schematic view of the dielectric layer 201, the first internal electrodes 202, the second internal electrodes 203, the first external electrode layer 204, and the second external electrode layer 205. In the figure, the peripheral portions of the first external electrode layer 204 and the second external electrode layer 205, that is, areas where the first external electrode layer 204 and the second external electrode layer 205 are present on the opposite sides via the dielectric layer 201 are indicated by black arrows. It should be noted that those areas are along the peripheries of the first external electrode layer 204 and the second external electrode layer 205. When a hydrate is generated in an area indicated by the black arrow, there is a possibility that a short-circuit fault occurs in the first external electrode layer 204 and the second external electrode layer 205. Hereinafter, the areas are each denoted as a short-circuit occurrence area T1.

Here, as described above, in the capacitor 100 according to this embodiment, at least one of the first external electrode layer 104 and the second external electrode layer 105 includes an opposing area and a non-opposing area, that is, the first external electrode layer 104 and the second external electrode layer 105 do not totally face each other via the dielectric layer 101 and are disposed with a displacement in the layer surface direction (a direction orthogonal to the thickness).

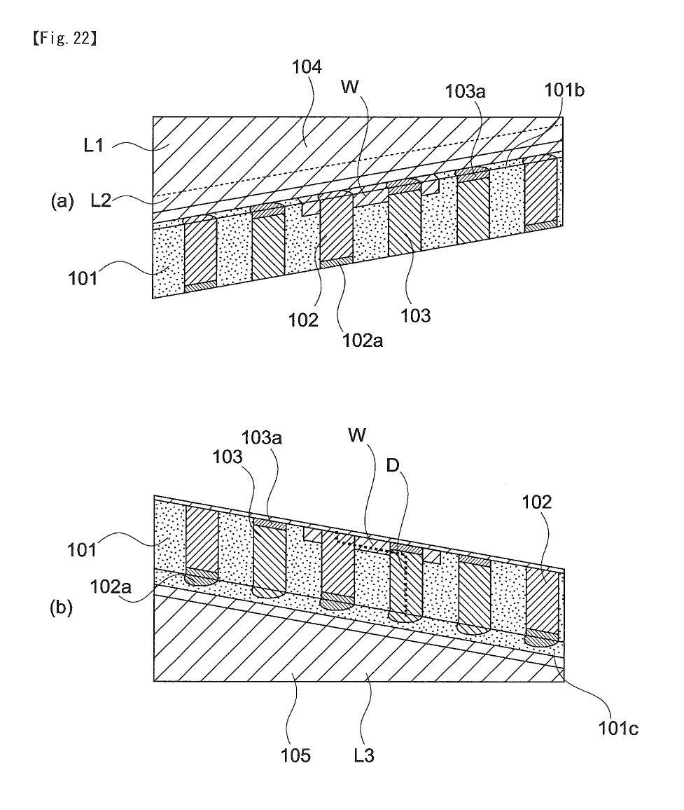

FIG. 22 is an enlarged view of the capacitor 100 in the peripheral portions of the first external electrode layer 104 and the second external electrode layer 105 and shows a state where the dielectric layer 101 is cut in the vicinity of the peripheral portions of the first external electrode layer 104 and the second external electrode layer 105. FIG. 22(a) is a view from the first surface 101b side. FIG. 22(b) is a view from the second surface 101c side. It should be noted that the first protective layer 106, the second protective layer 107, the first external terminal 114, and the second external terminal 115 are not illustrated in the figure. As described above, the first external electrode layer 104 and the second external electrode layer 105 do not totally face each other, and the first external electrode layer 104 includes the opposing area L1 and the non-opposing area L2. It should be noted that in the second external electrode layer 105, only the opposing area L3 is shown in the range shown in the figure.

Thus, even if the hydrate W is formed in the dielectric layer 101 in the peripheral portion of the first external electrode layer 104, and the first internal electrode 102 and the second internal electrode 103 are electrically connected to each other via the hydrate W as in the comparative example, the first external electrode layer 104 and the second external electrode layer 105 are not electrically connected to each other. This is because the second internal electrode 103 is not connected to the second external electrode layer 105 in the non-opposing area L2 of the first external electrode layer 104 (see FIG. 11).

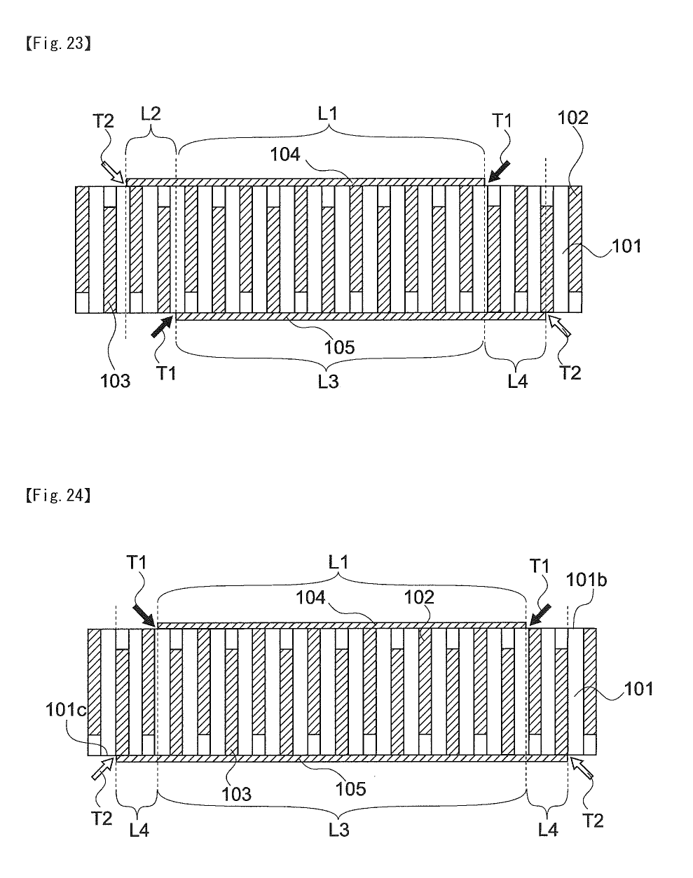

FIG. 23 is a schematic view of the dielectric layer 101, the first internal electrodes 102, the second internal electrodes 103, the first external electrode layer 104, and the second external electrode layer 105. In the figure, the peripheral portions of the first external electrode layer 104 and the second external electrode layer 105, that is, areas where the first external electrode layer 104 and the second external electrode layer 105 are present on the opposite sides via the dielectric layer 101 are indicated by black arrows. It should be noted that those areas are along the periphery of the opposing area L1 of the first external electrode layer 104 and the periphery of the opposing area L3 of the second external electrode layer 105. Hereinafter, the areas are each denoted as the short-circuit occurrence area T1.

Further, the peripheral portions of the first external electrode layer 104 and the second external electrode layer 105, that is, areas where the first external electrode layer 104 or the second external electrode layer 105 is not present on the opposite sides via the dielectric layer 101 are indicated by white arrows. It should be noted that those areas are along the periphery of the non-opposing area L2 of the first external electrode layer 104 and the periphery of the non-opposing area L4 of the second external electrode layer 105. Hereinafter, the areas are each denoted as a short-circuit prevention area T2.

When a hydrate is generated in the short-circuit occurrence area T1, as described above, there is a possibility that a short-circuit fault occurs in the first external electrode layer 104 and the second external electrode layer 105. When a hydrate is generated in the short-circuit prevention area T2, however, there is no possibility that a short-circuit fault occurs in the first external electrode layer 104 and the second external electrode layer 105. This is because the second internal electrode 103 is not connected to the second external electrode layer 105 in the non-opposing area L2 of the first external electrode layer 104, as shown in FIG. 23. Further, this is because the first internal electrode 102 is not connected to the first external electrode layer 104 in the non-opposing area L4 of the second external electrode layer 105.

As described above, in the capacitor 100 according to this embodiment, the first external electrode layer 104 includes the opposing area L1 and the non-opposing area L2, and the second external electrode layer 105 includes the opposing area L3 and the non-opposing area L4. Therefore, even if a hydrate is formed in the dielectric layer 101, it is possible to reduce a probability of occurrence of a short-circuit fault, compared with the capacitor 200 according to the comparative example.

Furthermore, as shown in FIG. 16, the opposing area L3 can be surrounded by the non-opposing area L4 in the second external electrode layer 105. FIG. 24 is a schematic view of the dielectric layer 101, the first internal electrodes 102, the second internal electrodes 103, the first external electrode layer 104, and the second external electrode layer 105 of the capacitor 100 in such a case.

In this case, over the entire circumference of the peripheral portion of the second external electrode layer 105, the first external electrode layer 104 is not present on the opposite side via the dielectric layer 101. Therefore, as shown in the figure, the entire circumference of the peripheral portion of the second external electrode layer 105 is the short-circuit prevention area T2. Further, over the entire circumference of the peripheral portion of the first external electrode layer 104, the second external electrode layer 105 is present on the opposite side via the dielectric layer 101. Therefore, as shown in the figure, the entire circumference of the peripheral portion of the first external electrode layer 104 is the short-circuit occurrence area T1.

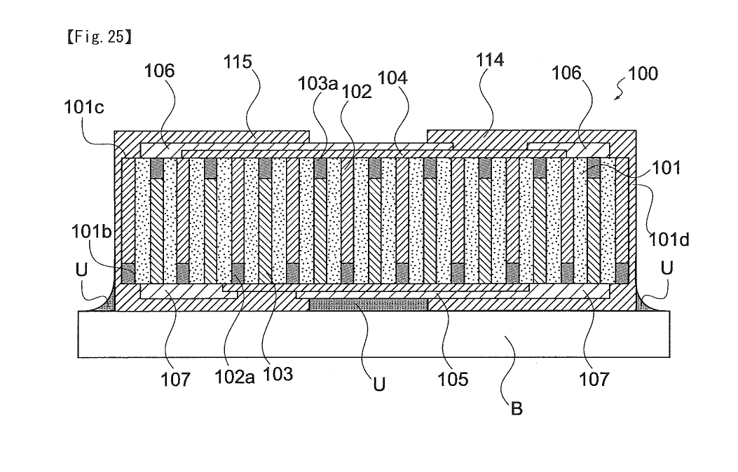

Specifically, in this configuration, the short-circuit occurrence area T1 is present only on one surface (first surface 101b side) of the capacitor 100. Here, when the capacitor 100 is mounted on a substrate, such a surface can be set to face a mount substrate. FIG. 25 is a schematic view showing a mount form of the capacitor 100 in such a case.

As shown in the figure, when the capacitor 100 is mounted on a mount substrate B, the first surface 101b side is mounted to face the mount substrate B, and the first surface 101b side of the capacitor 100 is covered by an underfill U. Thus, it is possible to prevent entry of moisture to the first surface 101b side by the underfill U and prevent the generation of a hydrate. As described above, since only the short-circuit prevention area T2 is present on the second surface 101c side, even if a hydrate is formed, a short-circuit fault can be prevented.

### [Method of Manufacturing Capacitor]

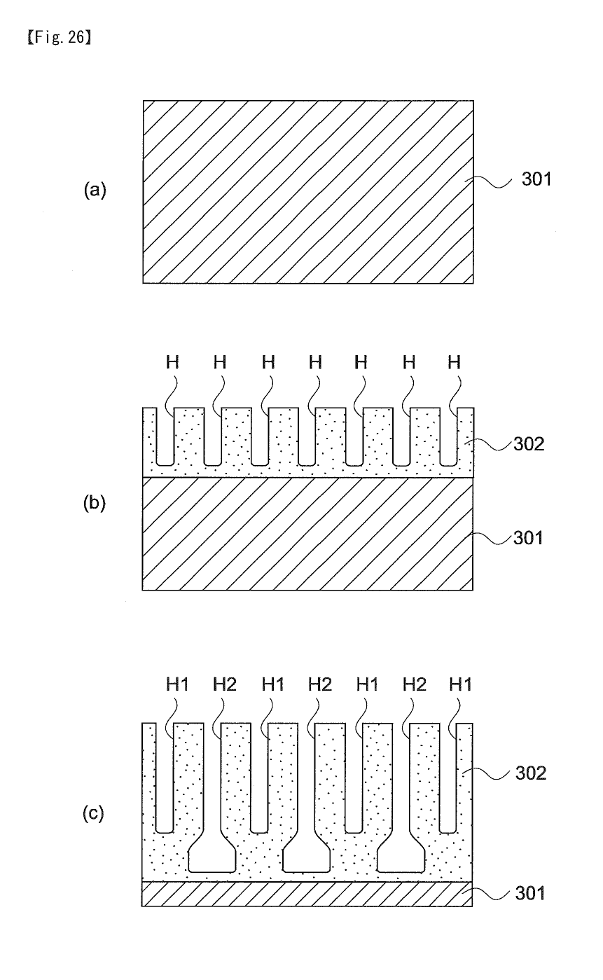

A method of manufacturing the capacitor 100 according to this embodiment will be described. It should be noted that the manufacturing method described below is only illustrative, and the capacitor 100 can be manufactured by a manufacturing method different from the manufacturing method described below. FIGS. 26 to 32 are schematic views showing a manufacturing process of the capacitor 100.

FIG. 26(a) shows a base material 301 that is to be the dielectric layer 101. When the dielectric layer 101 is made of a metal oxide (e.g., aluminum oxide), the base material 301 is a metal before oxidation of the metal oxide (e.g., aluminum).

For example, if a voltage is applied to the base material 301 as an anode in an oxalic acid (0.1 mol/l) solution controlled at a temperature of 15 to 20° C., as shown in FIG. 26(b), the base material 301 is oxidized (anodically oxidized) to form a base-material oxide 302. In this case, by the self-organizing effect of the base-material oxide 302, holes H are formed in the base-material oxide 302. The holes H grow in a direction of process of oxidation, i.e., in a thickness direction of the base material 301.

It should be noted that regular pits (concave portions) may be formed in the base material 301 before the anodic oxidation, and the holes H may be caused to grow based on the pits. The pit arrangement can control the array of the holes H. The pits may be formed by pressing a mold against the base material 301, for example.

After the elapse of a predetermined time period from the start of the anodic oxidation, the voltage applied to the base material 301 is increased. Since the pitches of the holes H formed by the self-organizing effect are determined depending on the magnitude of the applied voltage, the self-organizing effect proceeds so that the pitches of the holes H are enlarged. Thus, some holes H continue to be formed and enlarged in diameter as shown in FIG. 26(c). On the other hand, other holes H are formed very slowly due to the enlarged pitches of the holes H. Hereinafter, the holes H that are formed very slowly are denoted as holes H1, and the holes H that continue to be formed (enlarged) are denoted as holes H2.

The conditions of the anodic oxidation can be set arbitrarily. For example, at a first stage of the anodic oxidation shown in FIG. 26(b), the applied voltage can be set to several V to several hundred V and the processing time period can be set to several minutes to several days. At a second stage of the anodic oxidation shown in FIG. 26(c), the voltage value of the applied voltage can be set to several times greater than that in the first stage and the processing time period can be set to several minutes to several tens of minutes.

For example, the holes H each having a hole diameter of 100 nm are formed by setting the applied voltage at the first stage to 40V, and the holes H2 are each provided with an enlarged hole diameter of 200 nm by setting the applied voltage at the second stage to 80V. By limiting the voltage value at the second stage to the above-described range, the number of holes H1 and the number of holes H2 can be made almost equal. Moreover, by limiting the time period for applying the voltage at the second stage within the above-described range, the thickness of the base-material oxide 302 formed on the bottom portion by applying the voltage at the second stage can be decreased, while a pitch conversion of the holes H2 is fully achieved. Since the base-material oxide 302 formed by applying the voltage at the second stage is removed at a later process, it is desirable that the bottom portion be as thin as possible.

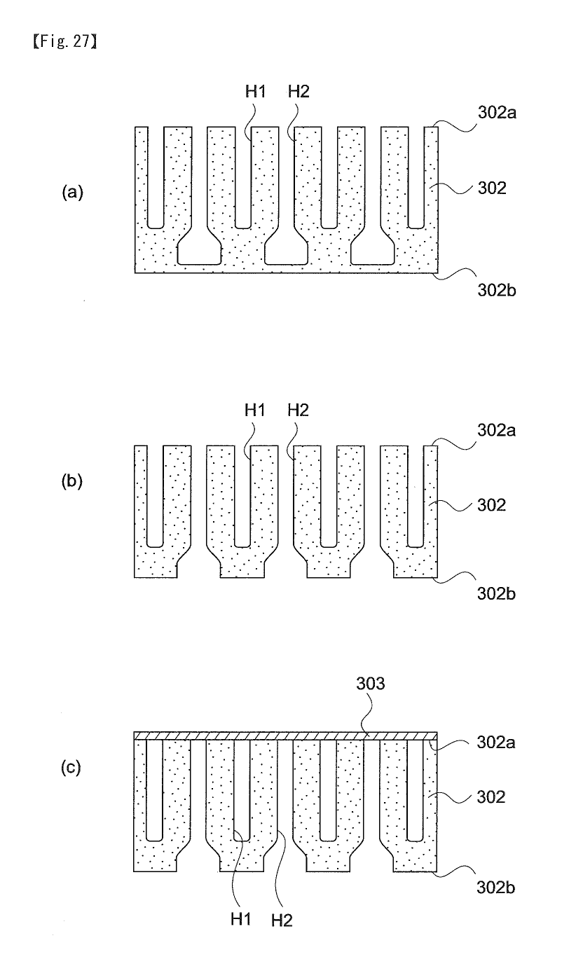

Subsequently, as shown in FIG. 27(a), the base material 301 not oxidized is removed. The removal of the base material 301 can be made by wet etching, for example. Hereinafter, a surface of the base-material oxide 302 where the holes H1 and H2 are formed is denoted as a front surface 302a, and the opposite surface thereof is denoted as a back surface 302b.

Subsequently, as shown in FIG. 27(b), the base-material oxide 302 is removed at a predetermined thickness from the back surface 302b. The removal can be made by a reactive ion etching (RIE). In this case, the base-material oxide 302 is removed at such a thickness that the holes H2 communicate with the back surface 302b but the holes H1 do not communicate with the back surface 302b.

Subsequently, as shown in FIG. 27(c), a first conductor layer 303 made of a conductive material is formed on the front surface 302a. The first conductor layer 303 can be formed by any method such as a sputtering method or a vacuum vapor deposition method.

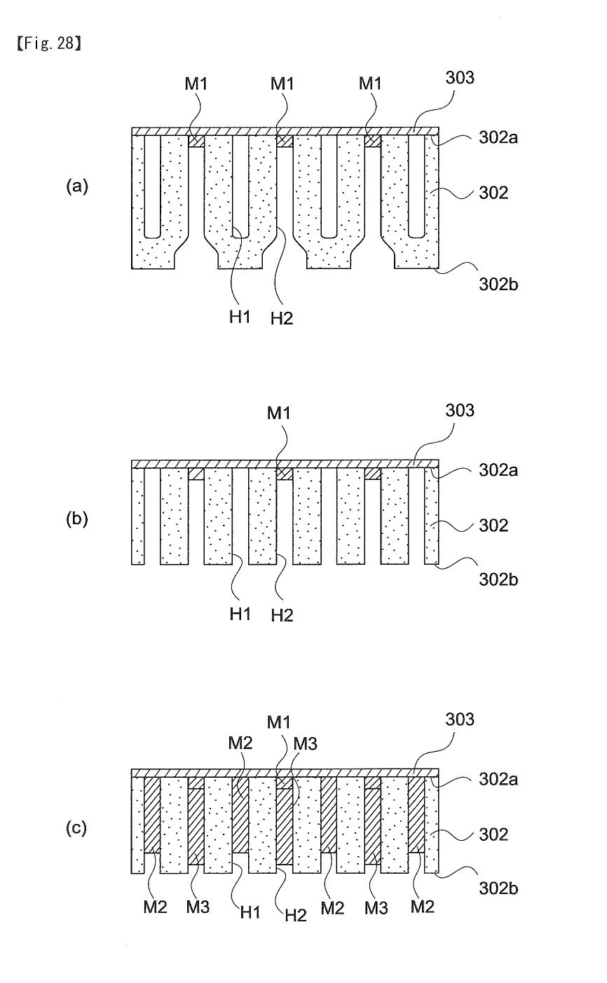

Subsequently, as shown in FIG. 28(a), first plating conductors M1 are embedded in the holes H2. The first plating conductors M1 can be embedded by applying electrolytic plating to the base-material oxide 302 using the first conductor layer 303 as a seed layer. Since a plating solution does not enter the holes H1, the first plating conductors M1 are not formed in the holes H1.

Subsequently, as shown in FIG. 28(b), the base-material oxide 302 is removed again at a predetermined thickness from the back surface 302b. The removal can be made by a reactive ion etching. In this case, the base-material oxide 302 is removed at such a thickness that the holes H1 communicate with the back surface 302b.

Subsequently, as shown in FIG. 28(c), second plating conductors M2 are embedded in the holes H1. Simultaneously, third plating conductors M3 are embedded in the holes H2.

The second plating conductors M2 and the third plating conductors M3 can be embedded by applying electrolytic plating to the base-material oxide 302 using the first conductor layer 303 as a seed layer. In this case, since the first plating conductors M1 are formed in the holes H2 in the preceding process, the tips of the third plating conductors M3 project more than the tips of the second plating conductors M2. Hereinafter, the first plating conductors M1 and the third plating conductors M3 are denoted as first internal conductors 304, and the second plating conductors M2 are denoted as second internal conductors 305.

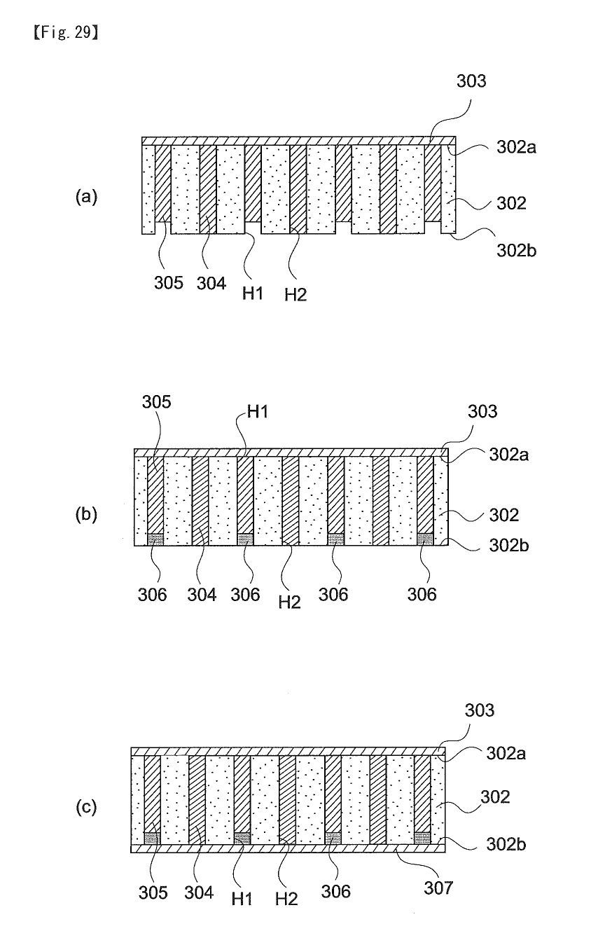

Subsequently, as shown in FIG. 29(a), the base-material oxide 302 is removed again at a predetermined thickness from the back surface 302b. The removal can be made by mechanical polishing or the like. In this case, the base-material oxide 302 is removed at such a thickness that the first internal conductors 304 are exposed to the back surface 302b and the first internal conductors 305 are not exposed to the back surface 302b.

Subsequently, as shown in FIG. 29(b), insulators 306 are embedded in the voids of the holes H1. The insulators 306 can be embedded by filling the voids with any insulating material.

Subsequently, as shown in FIG. 29(c), a second conductor layer 307 made of a conductive material is formed on the back surface 302b. The second conductor layer 307 can be formed by any method such as a sputtering method or a vacuum vapor deposition method.

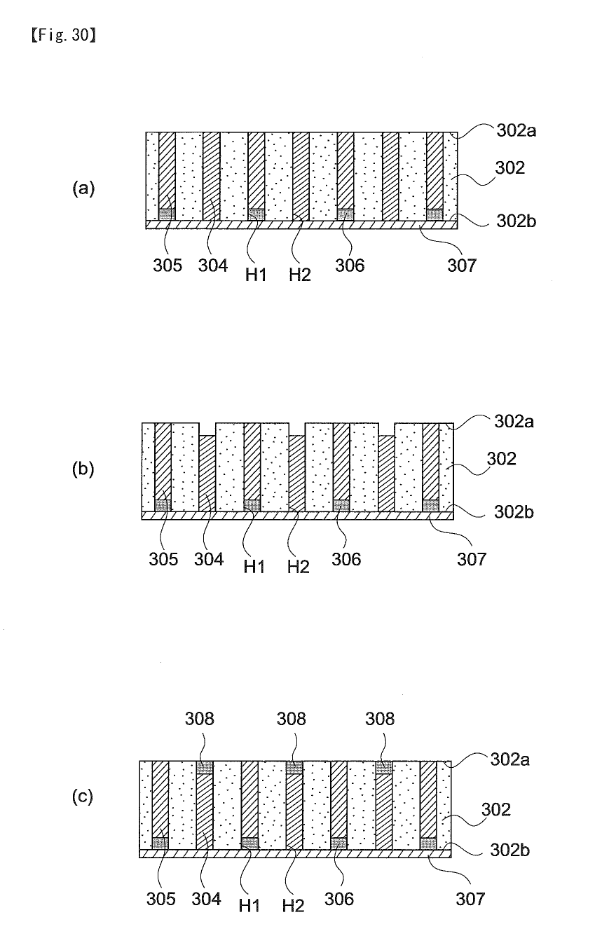

Subsequently, as shown in FIG. 30(a), the first conductor layer 303 is removed. The removal of the first conductor layer 303 can be made by a wet etching method, a dry etching method, an ion milling method, a chemical mechanical polishing (CMP) method, or the like.

Subsequently, as shown in FIG. 30(b), electrolytic etching is applied to the base-material oxide 302 using the second conductor layer 307 as a seed layer. Since the first internal conductors 304 are electrically connected to the second conductor layer 307, the first internal conductors 304 are etched by the electrolytic etching. Thus, voids from which the first internal conductors 304 are removed are formed in the holes H2. On the other hand, since the second internal conductors 305 are insulated from the second conductor layer 307, the second internal conductors 305 are not etched by the electrolytic etching.

Subsequently, as shown in FIG. 30(c), insulators 308 are embedded in the voids of the holes H2. The insulators 308 can be embedded by filling the voids with any insulating material.

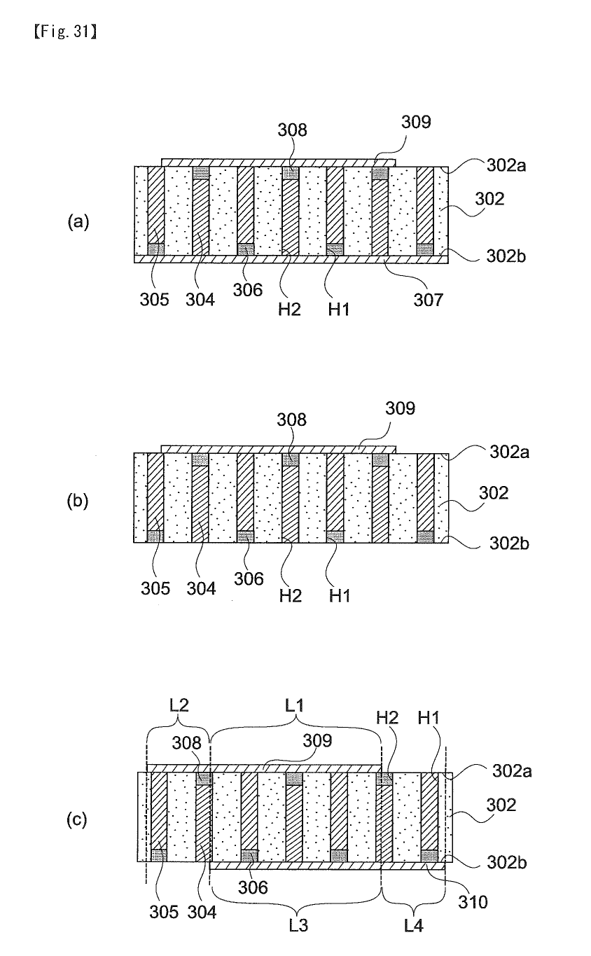

Subsequently, as shown in FIG. 31(a), a third conductor layer 309 made of a conductive material is formed on the front surface 302a. The third conductor layer 309 can be formed by any method such as a sputtering method or a vacuum vapor deposition method.

Subsequently, as shown in FIG. 31(b), the second conductor layer 307 is removed. The removal of the second conductor layer 307 can be made by a wet etching method, a dry etching method, an ion milling method, a chemical mechanical polishing (CMP) method, or the like.

Subsequently, as shown in FIG. 31(c), a fourth conductor layer 310 made of a conductive material is formed on the back surface 302b. In this case, the fourth conductor layer 310 can be formed with a displacement in the layer surface direction with respect to the third conductor layer 309. Thus, the fourth conductor layer 310 includes an opposing area L3 and a non-opposing area L4. The opposing area L3 is an area that faces the third conductor layer 309 via the base-material oxide 302. The non-opposing area L4 is an area that does not face the third conductor layer 309 via the base-material oxide 302. Further, the third conductor layer 309 also includes an opposing area L1 and a non-opposing area L2. The opposing area L1 is an area that faces the fourth conductor layer 310 via the base-material oxide 302. The non-opposing area L2 is an area that does not face the fourth conductor layer 310 via the base-material oxide 302.

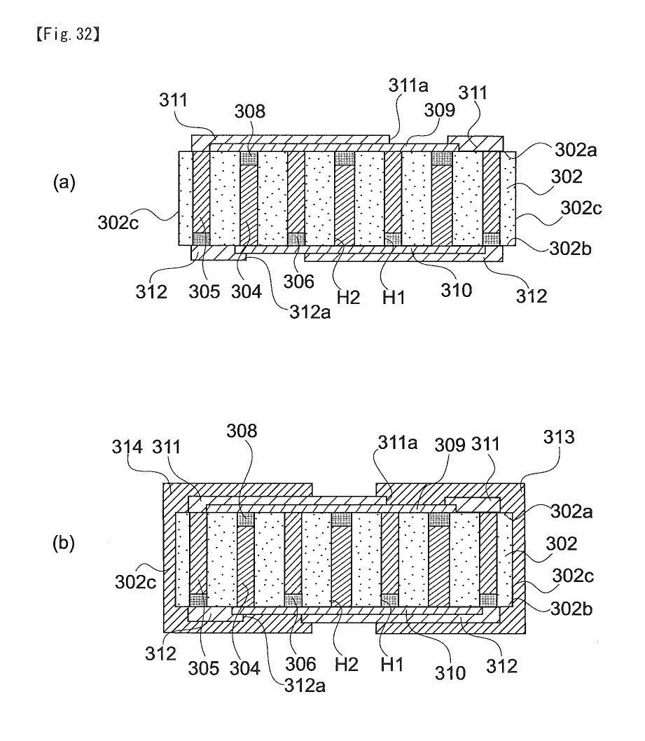

Subsequently, as shown in FIG. 32(a), a first protective layer 311 is disposed on the third conductor layer 309, and a second protective layer 312 is disposed on the fourth conductor layer 310. The first protective layer 311 and the second protective layer 312 can be formed by applying a resin material onto the third conductor layer 309 and the fourth conductor layer 310, respectively, and performing patterning by photolithography or the like. In the patterning, an aperture portion 311a from which the third conductor layer 309 is exposed is formed in the first protective layer 311, and an aperture portion 312a from which the fourth conductor layer 310 is exposed is formed in the second protective layer 312.

Subsequently, as shown in FIG. 32(b), a first external conductor 313 is disposed on a side surface 302c, the third conductor layer 309, the first protective layer 311, and the second protective layer 312. Further, a second external conductor 314 is disposed on the side surface 302c, the fourth conductor layer 310, the first protective layer 311, and the second protective layer 312.

The first external conductor 313 and the second external conductor 314 can be formed by applying a metal material onto the front surface 302a, the side surface 302c, and the back surface 302b, and performing patterning by photolithography or the like. By separation of the metal material in the patterning, the first external conductor 313 and the second external conductor 314 are formed.

The capacitor 100 can be manufactured as described above. It should be noted that the base-material oxide 302 corresponds to the dielectric layer 101, the second internal conductors 305 correspond to the first internal electrodes 102, and the first internal conductors 304 correspond to the second internal electrodes 103. The third conductor layer 309 corresponds to the first external electrode layer 104, the fourth conductor layer 310 corresponds to the second external electrode layer 105, the first protective layer 311 corresponds to the first protective layer 106, the second protective layer 312 corresponds to the second protective layer 107, the first external conductor 313 corresponds to the first external terminal 114, and the second external conductor 314 corresponds to the second external terminal 115.

### DESCRIPTION OF SYMBOLS

100 capacitor
101 dielectric layer
101a through-hole
101b first surface
101c second surface
102 first internal electrode
103 second internal electrode
104 first external electrode layer
105 second external electrode layer
L1, L3 opposing area
L2, L4 non-opposing area

1. A capacitor comprising:
a dielectric layer, having a first surface and an opposing second surface, the dielectric layer comprising a plurality of through holes extending from the first surface to the second surface;
a first external electrode layer on the first surface;
a second external electrode layer on the second surface, having a facing region facing the first external electrode layer through the dielectric layer, and having at least one non-facing region not facing the first external electrode layer through the dielectric layer;
first internal electrodes respectively provided in first ones of the through holes and electrically connected to the first external electrode layer;
second internal electrodes respectively provided in second other ones of the through holes and electrically connected to the second external electrode layer, and a portion of the plurality of through holes are formed and connected to the first external electrode layer, the first internal electrodes being separated from the second external electrode layer,
wherein at least one second other ones of through holes is electrically connected to the second external electrode layer at at least one non-opposing area.

2. The capacitor according to claim 1, wherein:
the first external electrode layer has an opposing area facing the second external electrode layer through the dielectric layer, and has a non-opposing area not facing the second external electrode layer.

3. The capacitor according to claim 1, further comprising:
an opposing area which is surrounded by the non-opposing area.

4. The capacitor according to claim 1,
a width of the non-opposing area is equal to or more than 0.1 μm and is equal to or less than 100 μm or more.

5. The capacitor according to claim 2, further comprising:
a first insulating material filled in gaps between the first internal electrodes and the second external electrode layer; and
a second insulating material filled in gaps between the second internal electrodes and the first external electrode layer.

6. The capacitor according to claim 4, wherein:
the dielectric layer is made of a material which forms a porous by self-assembly effect of anodic oxidation.

7. The capacitor according to claim 5, wherein:
the dielectric layer is made of aluminum oxide formed by anodic oxidation of the aluminum.

8. The capacitor according to claim 3, further comprising:
a first insulating material filled in gaps between the first internal electrodes and the second external electrode layer; and
a second insulating material filled in gaps between the second internal electrodes and the first external electrode layer.

9. The capacitor according to claim 1, further comprising:
an opposing area which is not surrounded by the non-opposing area.

10. The capacitor according to claim 2, wherein the opposing area is not surrounded by the non-opposing area.
